(19) United States
(12) Patent Application Publication
(10) Pub. No.: US 2005/0200836 A1
(43) Pub. Date: Sep. 15, 2005

(54) Fishing system

(76) Inventor: Sean K. Scorvo, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/077,633

(22) Filed: Mar. 9, 2005

Related U.S. Application Data
(63) Continuation-in-part of application No. 11/041,046, filed on Jan. 21, 2005.
(60) Provisional application No. 60/538,731, filed on Jan. 22, 2004.

(51) Int. Cl. G01B 11/26

(52) U.S. Cl. 356/138

(57) ABSTRACT

A device for use with a line holder capable of dispensing a line, comprising a length measurement device for measuring a length of line dispensed and an angle measurement device for measuring an angle of the line. A calculation device is used to calculate an approximate position of an object attached to the line based upon the measured length and the measured angle. The measurement and calculation devices may be mounted to a fishing rod and reel, allowing the user to measure the depth of underwater equipment.

### CROSS-REFERENCE TO RELATED APPLICATIONS

This application is a continuation-in-part of co-pending application Ser. No. 11/041046, filed Jan. 21, 2005, entitled FISHING SYSTEM, which claims the benefit of U.S. provisional application Ser. No. 60/538,731, filed on Jan. 22, 2004, entitled FISHING SYSTEM.

### BACKGROUND OF THE INVENTION

The present invention relates to a depth measuring device. More particularly, the present invention relates to a device for measuring the depth of equipment in a dynamic underwater environment.

Existing devices for measuring the depth of underwater equipment include pressure bathometers, downriggers, and sonar fathometers. Their measurements are based on the concepts of water pressure, length of an attaching line, and reflection of sound waves, respectively. Such devices are unsatisfactory for measuring the depth of equipment in a dynamic underwater environment.

Surveyors, especially geologists and foresters, have long relied on clinometers and hypsometers for measuring object heights and surface depressions on or above the ground, using manual measurements and optical alignment techniques. In particular, hypsometers are used for establishing elevations and altitudes in geographical mapping based upon measuring the distance to an object (usually laser and ultrasound range finders), and the angle of the hypsometer relative to the top of the object (requiring visual alignment of the device with the object's highest elevation). The hypsometer calculates the height of the object using trigonometric techniques. In particular, the clinometer is a device within the hypsometer that measures the tilt (angle) of the hypsometer relative to a zero point (a level base).

Sonar fathometers and pressure bathometers tend to be heavy, complex, and require data transmission back to the meter. The downrigger is a simple device that lets out a certain amount of line with a weight attached near its end pulling the lure to the desired depth. However, the downrigger tends to provide inaccurate depth measurements as soon as the angle of incidence of the line to the water deviates from 90 degrees, as will occur in a dynamic underwater environment (for example, the effects of trolling or underwater currents). Clinometers designed for the measurement of surface features are not suitable for underwater measurements because they require visual alignment with the object in question, a luxury not available in murky underwater conditions and parallax effects of the water even when the water is clear.

What is needed, therefore, is a device that provides reliable underwater measurement of the depth of equipment.

### BRIEF DESCRIPTION OF THE DRAWINGS

For a more complete understanding of the present invention, the drawings herein illustrate examples of the invention. The drawings, however, do not limit the scope of the invention. Similar references in the drawings indicate similar elements.

FIG. 1 illustrates trigonometric relationships associated with measurements of the height of an object.

FIG. 2 illustrates trigonometric relationships associated with measurements of the depth of an object.

FIG. 3 illustrates azimuth deviation associated with measurements of the depth of an object.

FIG. 4 illustrates an exemplary measurement system, according to one embodiment of the invention, for measuring the approximate position of an object in water.

FIG. 5 illustrates in greater detail the measurement system depicted in FIG. 4.

FIG. 6 illustrates an exemplary angle measurement device, according to one embodiment of the invention.

FIG. 7 illustrates an exemplary measurement system, according to one embodiment of the invention.

FIG. 8 illustrates in greater detail the measurement device depicted in FIG. 7.

FIG. 9 illustrates a top view of the measurement device depicted in FIG. 8.

### DETAILED DESCRIPTION OF THE PREFERRED EMBODIMENTS

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

Various operations will be described as multiple discrete steps performed in turn in a manner that is helpful for understanding the present invention. However, the order of description should not be construed as to imply that these operations are necessarily performed in the order they are presented, nor even order dependent.

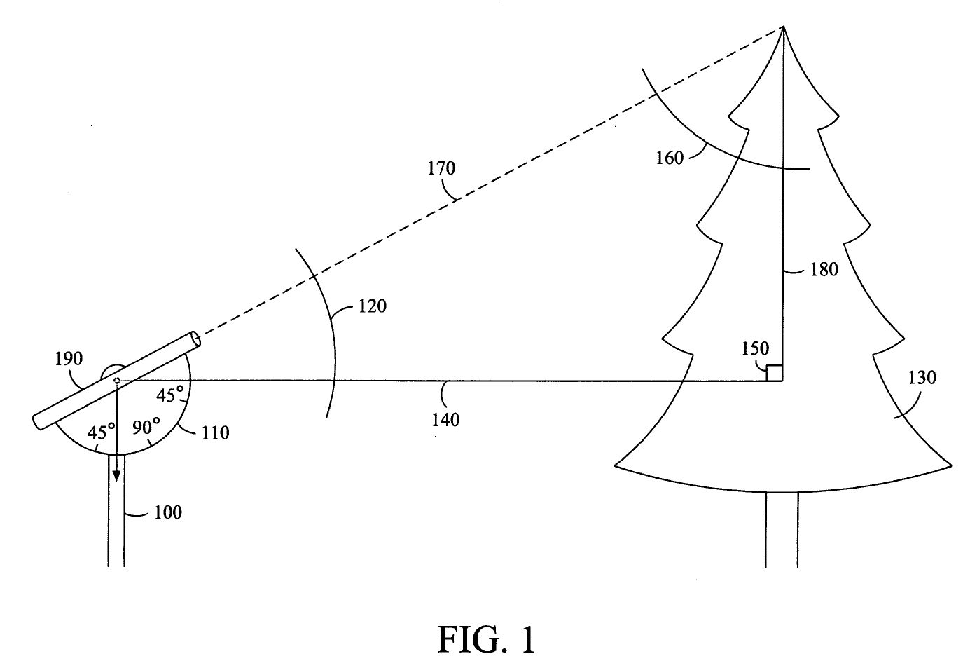

FIG. 1 illustrates trigonometric relationships associated with measurements of the height of an object. Diagrammed is a stand 100 of known height with a mounted mechanical clinometer 110. The clinometer 110 measures the angle 120 from the horizontal (determined by leveling the base). The optical sighting device 190 on the clinometer allows for visual alignment with the top of the object of interest 130. As diagrammed, the alignment with the object leaves one with a virtual triangle having sides 140, 170, and 180. In order to calculate the height of the object 130 using such clinometer, the distance 140 to the object 130 is known and angle 150 is 90 degrees (leaving a right triangle having sides 140, 170, and 180). Using well-known trigonometric relationships, the height component 180 of the object 130 is given by the product of the tangent function of the angle 120 and the distance 140. The height of the object 130, as shown in FIG. 1, is therefore the sum of the calculated height component 180 and the height of the stand 100.

It is well understood that other relationships may be used to calculate various relationships illustrated in FIG. 1. For example, the angle 160 may be calculated by subtracting measured angle 120 and right angle 150 (90 degrees) from 180 degrees, the sum of the angles forming any closed triangle. The hypotenuse 170 may be calculated by dividing the height component 130 by the sine function of measured angle 120. Also, the Pythagorean theorem may be used to calculate the hypotenuse 170. That is, the hypotenuse 170 may be calculated by taking the square root of the sum of the squares of the distance 140 and the height component 180.

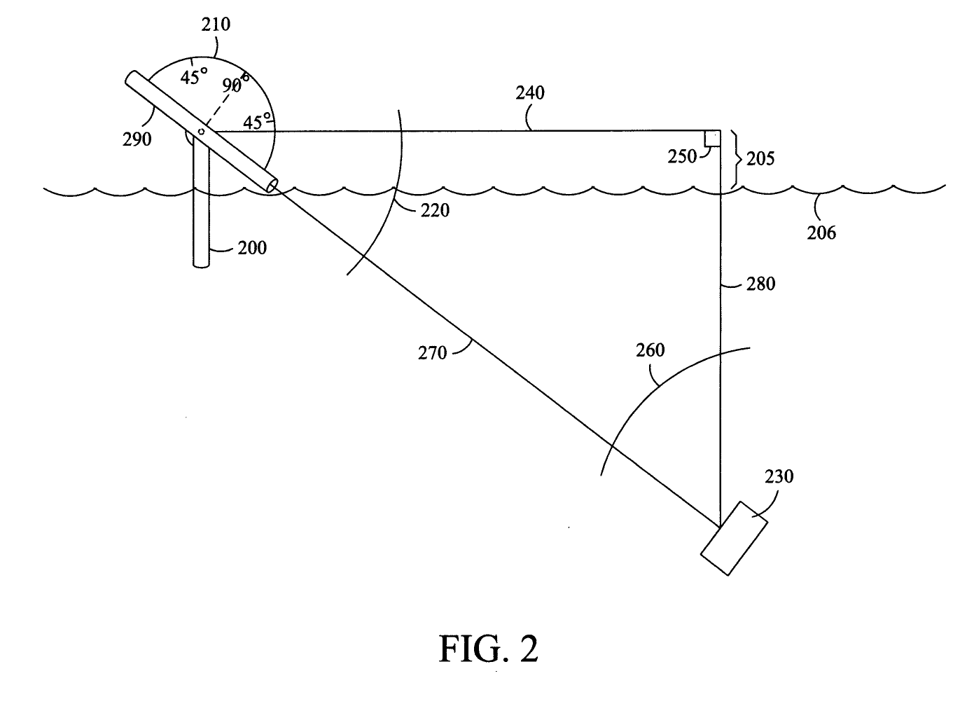

Similar trigonometric relationships are associated with a configuration for measuring the depth of a subsurface object 230, as illustrated in FIG. 2. As shown, a stand 200 of height 205 above the surface 206 is supporting the clinometer 210 for measuring the angle 220 between an object 230 and the horizontal (determined by leveling the base). The optical sighting device 290 on the device is directed toward the object 230. As diagrammed, alignment with the object 230 leaves one with a virtual triangle having sides 240, 270, and 280. In order to calculate the depth of the object 230 using such clinometer, the hypotenuse 270 to the object 230 is known and the angle 250 is 90 degrees (leaving a right triangle having sides 240, 270, and 280). Using trigonometric relationships the depth component 280 of the object 230 is given by the product of the sine function of the angle 220 and the hypotenuse 270, where the hypotenuse 270 may be given, according to the configuration in FIG. 2, by measuring a length of line extending from the clinometer 210 to the object 230. The depth below the surface 206 of the object 230, as shown in FIG. 2, is therefore the difference of the calculated depth component 280 and the known height of the stand 200.

As in FIG. 2, it is well understood that other relationships may be used to calculate various relationships illustrated in FIG. 2. For example, the angle 260 may be calculated by subtracting measured angle 220 and right angle 250 (90 degrees) from 180 degrees, the sum of the angles forming any closed triangle. The range 240 may be calculated by multiplying the hypotenuse 270 by the cosine function of measured angle 220. Also, the Pythagorean theorem may be used to calculate the range 240. That is, the range 240 may be calculated by taking the square root of the difference of the square of the hypotenuse 270 less the square of the depth component 280.

Clinometers as in FIG. 2, however, require manual calculations, and the manual nature of using the clinometer 210 as a depth gauge, unfortunately, makes accurate determination of the depth of the object 230 in a dynamic underwater environment impractical. Using the clinometer 210 as illustrated in FIG. 2 requires measuring the length of the line (hypotenuse 270) to the object 230, determining the angle of the clinometer 210 to the surface 206 (that is, leveling the clinometer 210), attempting (visually) to ensure that the object is in alignment with the clinometer 210, reading a protractor associated with the clinometer 210 to obtain the angle 220 of the line 270 incident to the surface 206, and, finally, manually calculating the depth of the object 230. For example, if the configuration illustrated in FIG. 2 represents use of a mechanical clinometer 210 to measure the approximate position of an object 230 such as a fishing lure below the surface of the water 206, varying conditions such as the speed of the fishing lure traveling through the water and rapid changes in the orientation of the clinometer 210 relative to the water surface 206 render such a manual depth measurement impractical.

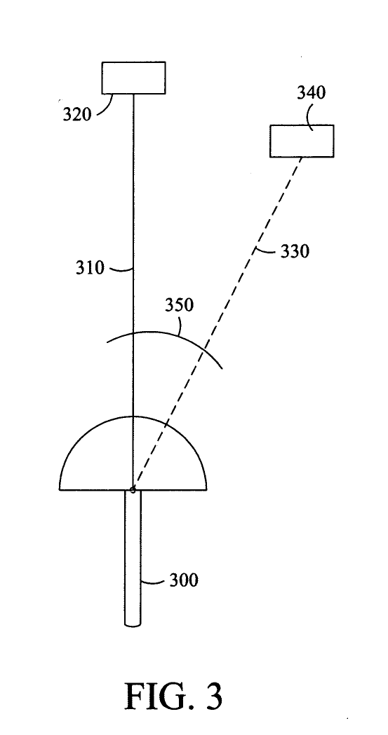

Moreover, visual alignment of the mechanical clinometer 210, as mentioned above, is needed in order to eliminate azimuth deviation that might adversely affect the accuracy of such mechanical clinometers. FIG. 3 depicts azimuth deviation associated with measurements of the depth of an object using a mechanical clinometer such as the clinometer 210. As shown in a top view, the clinometer 300 is optically sighted along the line 310 and the object 320 such as a fishing lure attached to the end of the line 310. Here, the clinometer 300 is aligned with the line 310. If, for example, the object 320 shifts in relative position to become oriented as the object 340, as illustrated, then the line 310 is re-oriented as the line 330 thereby introducing azimuth deviation 350. Because an underwater object often cannot be directly observed, it is only the attaching line that can be manually aligned with the clinometer in order to eliminate the potential of azimuth induced measurement error, and then only momentarily since the line is constantly moving in three dimensions.

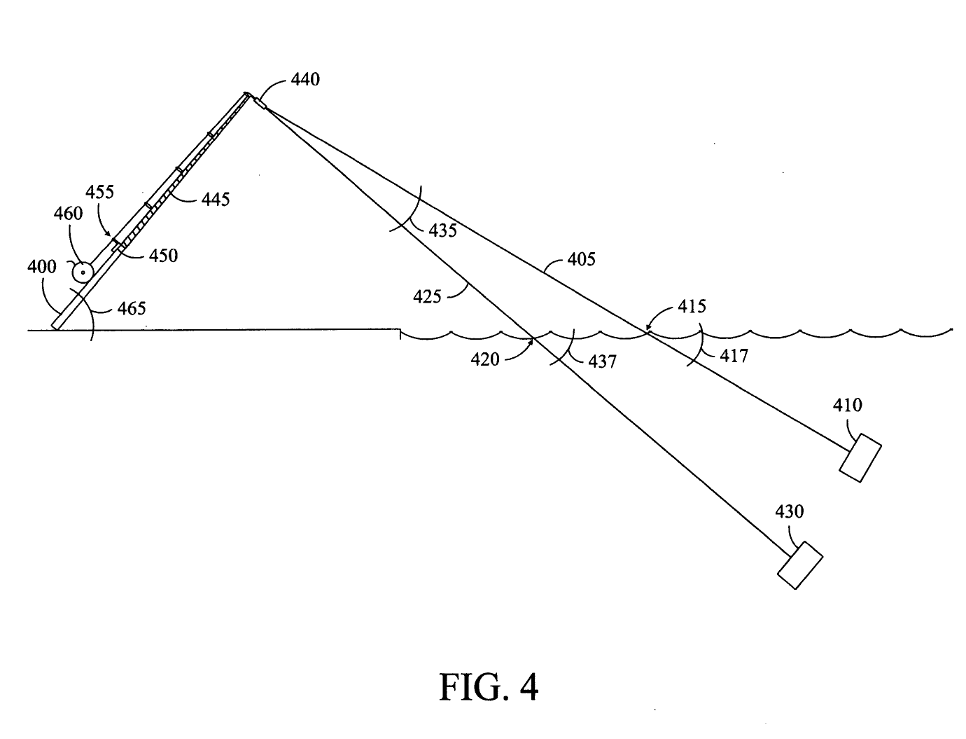

FIG. 4 illustrates an exemplary measurement system, according to one embodiment of the present invention, for measuring the approximate position of an object in water. The line holder 400 is capable of dispensing line 405 attached to an object 410. The measurement system includes a measurement device 455 capable of measuring a length of line 405 dispensed from the line holder 400 and a measurement device 440 capable of measuring an angle of line 405 dispensed from the line holder 400. A calculation device 450 is capable of calculating an approximate position of object 410 attached to the line 405. The calculation device calculates the approximate position based upon the measured length of line dispensed from the line holder and the measured angle of the line dispensed from the line holder.

The fishing pole may comprise a fishing rod 400 and a line dispensing reel 460. Such a fishing pole may comprise any of a wide variety of commercially available or specially fabricated fishing reels or line dispensers.

As illustrated in FIG. 4, the measurement device 440 may include a clinometer capable of measuring the angle of the line 405 in relation to a reference plane. The measurement device 440 may measure the angle 417 between the line 405 and the plane of the waterline 415. The measurement device 440 may measure the angle between the line holder 400 and the line 405. Further, the measurement device 440 may measure changes in the angle 417 between the line holder 400 and the line 405 that occur due to a change in the approximate position of the object 410 (e.g movement from the approximate postion of object 410 to the approximate position of object 430). The measurement device 440 may be an electronic device capable of measuring changes in the angle between the line holder 400 and the line 405 (e.g. from the angle 417 to the angle 437).

The measurement device 440 may communicate angular changes via wires 445 attached to the line holder 400 to the calculation device 450, and the measurement device 455 similarly may communicate line length changes to the calculation device 450. The measurement devices 440 and 455 may share a common physical package and may also share a common physical package with the calculation device 450. Likewise, the measurement devices 440 and 455 and the calculation device 450 may be communicably interconnected in a wide variety of ways so as to permit efficient operation. For example, the calculation device 450 may be located as shown in FIG. 4, lower on the line holder 400 to allow for easier user operation and control of the device, with one or both of the measurement devices 440 and 455 wirelessly in communication with the calculation device 450.

The calculation device 450 may include a display feature for displaying the approximate position of the object 410 attached to the line 405. The display device is capable of displaying the approximate position of the object 410 attached to the line 405 including at least one of a horizontal range (horizontal distance) between the line holder 400 and the object 410, a vertical depth (vertical distance) between the line holder 400 and the object 410, and a straight-line distance (hypotenuse distance) between the line holder 400 and the object 410.

The calculation device 450 is capable of calculating the approximate position of the object 410 attached to the line 405 dispensed from the line holder 400, whereby the approximate position calculated takes into account the relative position of the line holder 400 itself and characteristic attributes of the line holder 400. For example, the calculation device 450 is capable of adjusting the calculated approximate position of the object 410 to reflect the length of the line holder 400, to produce an approximate position of object 410 relative to a user holding or operating the line holder 400. In one instance, the calculated approximate position may be the depth of the object 410 below the waterline 415. In another instance, the calculated approximate position may be the previously mentioned depth with an offset to account for a distance between the waterline 415 and a reference point above or below the waterline 415.

The calculation device 450 is capable of calculating the approximate position of the object 410 as the object 410 moves about in relation to the line holder 400, and, in particular, in relation to the angle and length measurement devices 440 and 455, taking into account variations in the angle 465, the angle between the line holder 400 and the horizontal reference plane. As will be discussed in greater detail below, in one embodiment, the angle measurement device 440 is capable of measuring the angle between the line 405 extending to the object 410 and one or both of a horizontal reference plane and a vertical reference plane as well as the angle 465 so that the calculation device 450 may calculate the approximate position of the object 410 with improved accuracy.

In one embodiment, similar trigonometric relationships as in FIG. 2 are associated with the measurement system illustrated in FIG. 4 for measuring the depth of a subsurface object. The line holder 400 may have a known longitudinal length between its base and the line-guide or far end of the line holder 400. Since the angle 465 may be measured by the angle measurement device 440 or calculated using measurements from the angle measurement device 440, the height above the surface 415 (the vertical distance between the line-guide or far end of the line holder 400 and the surface 415) may be determined. For example, the height above the surface 415 may be calculated as the product of the sine function of the angle 465 and the known longitudinal length of the line holder 400. With the height above the surface 415 known, the depth of the object 410 may be found by subtracting this height value from the calculated vertical distance between the line-guide or far end of the line holder 400 and the object 410.

The measurement device 440 may measure the angle 417 between the line 405 extending to the object 410 and a horizontal reference plane (determined internally to the measurement device 440). The measurement device 455 measures a length of the line 405 comprising the hypotenuse or straight-line distance from the line-guide or far end of the line holder 400 and the object 410. Thus, the vertical distance between the line-guide or far end of the line holder 400 and the object 410 may be calculated as the product of the sine function of the angle 417 and the hypotenuse or straight-line distance from the line-guide or far end of the line holder 400 and the object 410. As described, the measurement system as illustrated in FIG. 4 may be used for measuring the depth of a subsurface object.

There are many possible uses for such a measurement system. For instance, one may make measurements of subsurface contours by mapping the depth of a weight (or similar ‘end point’) at various points relative to the measurement system. The measurement system would afford much more rapid subsurface surveying than is possible with manual devices utilizing a plumb line. For example, as illustrated in FIG. 4, one is able to survey the bottom of a pond by simply casting a weight with a typical fishing rod to different areas, the measurement system and associated devices then calculating the distance of each cast (in terms of a horizontal range as well as a straight-line or hypotenuse distance) and the depth that the weight sinks to.

One may also measure the depth of fishing gear when trolled behind a boat or retrieved via line and reel. Such applications involve dynamic environments, subject to rapid depth and azimuth variations. By contrast, available depth determining devices are quite limited in their ability to convey information. For example, fishermen have been limited to “line counting” reels that read the amount of line released from the reel but not the actual depth of the lure/gear or line grabbing devices such as those described in United States patent application number 20010045049 that are limited in their utility and measure only static depths in a non-dynamic environment (i.e. bottom fishing in a currentless body of water).

A measurement system as in FIG. 4 offers one or more additional advantages. Such a measurement system would not be subject to the range limitations of devices that use sonar beams or the difficulties of transmitting data from a pressure bathometer back to the reader via cables. Likewise, a measurement system as in FIG. 4, comprising devices used above the waterline, avoids the costs incurred with the loss of expensive undersurface devices on subsurface obstacles. As previously mentioned, such a measurement system avoids the inaccurate depth measurements with downriggers because the effects of trolling or underwater currents may be accounted for in the calculation of the approximate position of the object attached to the line. And also as previously mentioned, such a measurement system overcomes the visual alignment problems inherent with mechanical clinometers. That is, a measurement system as in FIG. 4 does not require visual alignment with the target object, thus avoiding the error introduced by parallax effects, limited visibility due to murky water conditions, and so on. Furthermore, such a measurement system as in FIG. 4 does not penalize the intended motion of baits or lures by weighing the baits or lures down with measuring devices.

Other configurations for the invention are readily apparent such as the system need not comprise a fishing rod and reel. The concepts and equations may be applied to other configurations. For example, the concepts and equations may be applied to a downrigger for increased accuracy of the depth measurement of the downrigger.

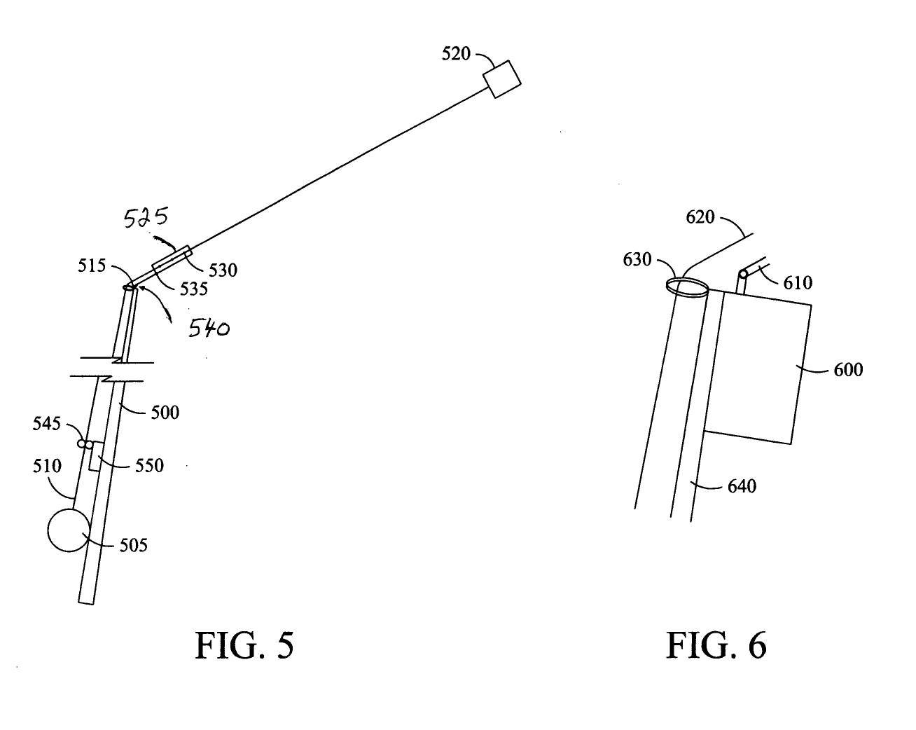

FIG. 5 illustrates in greater detail the measurement system depicted in FIG. 4. As shown, the line holder 500 includes a fishing rod with a line dispenser 505 comprising a fishing reel attached to the fishing rod. The line 510 is dispensed from the line holder 500 outward longitudinally along the line holder 500, through a line-guide 515 (or far end of the line holder 500) and outward to the object 520 connected to the far end of the line 510. An angle measurement device 525 is mounted so that the line 510 may pass freely through one or more line guides 530. The angle measurement device 525 is connected to line holder 500 via one or both of connecting points 535 and 540. The connecting point 540 comprises a pivot point between the longitudinal member of the line holder 500 and the angle measurement device 525. The angle measuring device 525 is selectively securable to the line holder 500.

The angle measurement device 525, mounted as shown, is capable of measuring the angle between a portion of a length of the line 510 extending from the connecting point 540 and the object 520 and a horizontal reference plane. The angle measurement device 525 is capable of measuring the angle between a portion of a length of the line 510 extending from the connecting point 540 and the object 520 and the longitudinal member of the line holder 500. The angle measurement device 525 comprises an electronic or solid-state clinometer device capable of providing one or both of digital and analog output signals. The electronic or solid-state clinometer may comprise a “tilt sensor,” “accelerometer,” or “inclinometer.” However, the angle measuring device 525 may comprise any of a wide variety of devices capable of providing the aforementioned angular measurements. The angle measurement device 525 may comprise any device for measuring angles. For example, the angle measurement device 525 may measure gyroscopic forces, optical deviation, diffraction, or orientation of electrolytic solutions in relation to electrodes.

Other configurations for the invention are readily apparent such as the electronic or solid-state clinometer may be located anywhere on the line holder, including, for example, the reel. The angle measurement device 525 illustrated in FIG. 5 may comprise a tilt sensor mounted in the line dispenser 505 wherein the line dispenser 505 comprises a fishing reel.

Still referring to FIG. 5, the line 510 passes through a length measuring device 545 capable of measuring a portion of a length of the line 510. The length measuring device 545 comprises an electronic or solid-state device capable of measuring a portion of a length of the line 510 dispensed from the line dispenser 505 and providing one or both of digital and analog output signals. The measured portion of the line 510 comprises the hypotenuse or straight-line distance between the line-guide 515 (or far end of the line holder 500) and the object 520. The length measuring device 545 may comprise a device using any technology for measuring length. The length measurement device 545 may measure specially marked line 510 dispensed from the line dispenser 505. Such a technology may comprise specially produced line 510 with optical reflectors or absorbers at specific points, whereby the length measuring device 545 “counts” the amount of line 510 dispensed. Another technology may comprise counting the number of revolutions of the line dispenser 505 as the line 510 is dispensed, also known as “line counting.” Or, a pinch roller arrangement may be used, as illustrated in FIG. 5. The pinch roller device may be calibrated for measuring the amount of line 510 dispensed. The pinch roller device allows for the use of commonly available materials for line 510 and also the use of different diameters or strengths of line 510. The length measurement device 545 may comprise a device using any technology for measuring length. The length measurement device 545 may comprise a pinch roller device that is built into the calculation device 550. The length measurement device 545 may be built into the line dispenser 505.

The measured hypotenuse and measured angle are provided to the calculation device 550 attached to the line holder 500. The calculation device 550 is capable of calculating an approximate position of a part of the line 510. The part of the line 510 is the location of the object 520 as shown in FIG. 5. Further, the calculation device 550 calculates the approximate position based upon a measured length of line 510 dispensed from line holder 500 and a measured angle of line 510. The calculation device 550 comprises an electronic or solid-state device. The calculation device 550 may further comprise a microprocessor that may be programmed to calculate a spatial relationship in at least one of two and three dimensions of the approximate position of the object 520. The approximate position includes one or more of horizontal range, vertical depth, and straight-line distance. Further, the calculation device 550 may be programmed to account for error due to one or more of several factors. The factors include but not limited to a diameter of line 510, a weight of object 520, a shape characteristic of object 520, a speed of object 520, a deflection characteristic of line 510, and an offset (depth adjustment). The slack in the line 510 between the line-guide 515 (or far end of the line holder 500) and the object 520 is minimized to minimize error in the measurement calculations.

The calculation device 550 may be programmed to calculate depth of the object (here, the object 520), slope and distance between two selected points, and the spatial relationship between the selected points in at least one of two and three dimensions. For example, one may use a measurement system as in FIG. 5 to measure the approximate position of a particular location (i.e. a particular fishing site) and subsequently measure the approximate position of a second particular location. One may then find the slope and distance between the two locations using the calculation device 550. Likewise, one may find the spatial relationship in at least one of two or three dimensions between the two locations.

To facilitate the aforementioned operation, a display and programming interface are useful. The calculation device may comprise a display for viewing the calculated measurements or other pertinent information. The display may comprise any of a wide variety of displays. The display may comprise a liquid crystal display (LCD).

The calculation device (such as the calculation device 550) includes a programming or controls interface. The interface may comprise simple push buttons, keyboard inputs, or any of a wide variety of interface devices. The calculation device 550 may comprise push buttons for specifying the measuring function desired, navigating through programming steps, entering setup parameters, and so on. A scroll key may be incorporated into the calculation device 550. The scroll key feature may be used to select various depth or other measurement functions to be displayed or to program the calculation device to perform any of the aforementioned calculations. For example, it may be desirable to set a “zero point” (starting point) for the measurements to be taken. As another example, as mentioned previously, it may be desirable to set a different value (i.e. length or selection from a predetermined set of values) for the length of the line holder 500. The different value may be used by the calculation device 550 to adjust the calculated approximate position of the object 520. Such settings may be entered using an interface feature of the measurement system. The interface feature and display may be integrated with the calculation device as illustrated in FIG. 5.

Next, FIG. 6 illustrates an angle measurement device mounted near the line-guide or far end of the line holder. Such a device may further reduce angle measurement error due to deflection of the line caused by the weight of the angle measuring device itself. The angle measurement device shown in FIGS. 5-6 are constructed of lightweight materials to reduce error due to line deflection. The one or more devices comprising the measurement system are mountable on the line holder at a location such that the weight of the one or more devices does not cause the measurement system to bow. As shown, the angle measurement device 600 comprises an angle measuring element 610 that moves along with deflections and changes in position of the line 620. The angle measurement device 600 is attached near the line-guide 630 (also referenced as the far end of line holder 640). Use of such an angle measurement device 600, or of an angle measurement device 525, allows for the minimization of error caused by azimuth deviation, eliminating the need for optical alignment with the target object. This is because the angle measuring devices follow the movement of the line extending toward the target object.

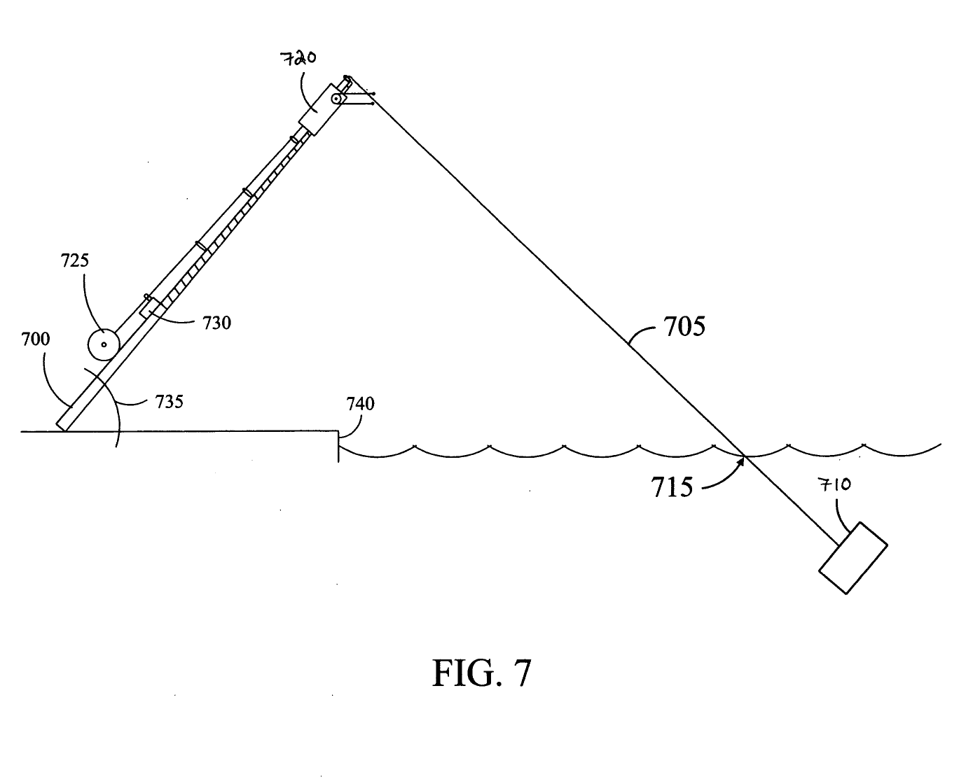

Many different configurations for the invention are possible. For example, FIG. 7 illustrates an example wherein angle and length measuring devices are integrated. As shown, the line holder 700 is used with the line 705 and connected to the object 710 below the surface 715. The measurement device 720 is mounted on the end of the line holder 700 and receives the line 705 from the line dispenser 725. The calculation and display device 730 is attached to the line holder 700 as shown. The calculation and display device 730 calculates and displays the approximate position of the object 710. The calculations are based upon length and angle measurements received from the measurement device 720. The measurement device 720 is capable of measuring the length of the line 705, the angle 735, and the angle of the line 705 extending outward to the object 710. The calculation and display device 730 then calculates and displays the approximate position of the object 710 using the simple geometric and trigonometric relationships discussed previously. Depth offsets such as the offset 740 may be entered into the calculation and display device 730.

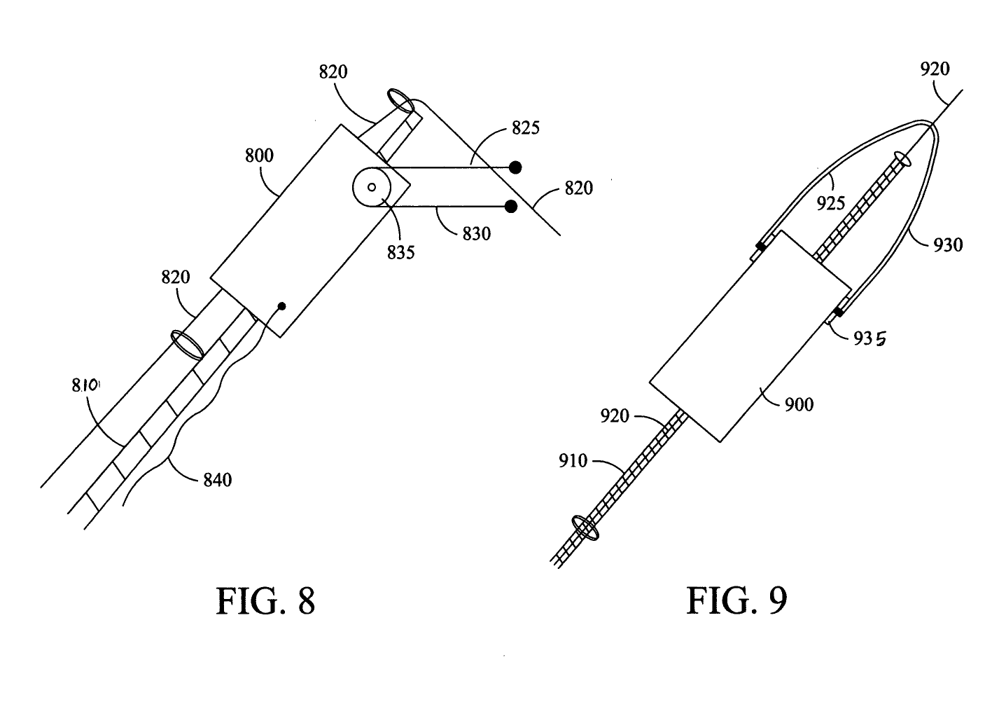

FIG. 8 illustrates in greater detail the measurement device depicted in FIG. 7. The side view in FIG. 8 illustrates the measurement device 800 attached to the line holder 810 and allowing the line 820 to pass freely through the measurement device 800 or near enough to the measurement device 800 for length measurement. The measurement device 800 comprises a pinch roller or other measuring technology for measuring the line 820 passing through the measurement device 800. Angle measurement is accomplished with the use of an upper line-guide 825 and a lower line-guide 830, between which the line 820 extends outward toward the target object (i.e. the object 710). The pivot point 835 comprises a rotary sensor or other type of angle sensor or angle measurement device. The angle sensor may comprise a potentiometer type of analog sensor, a Hall Effect type of digital sensor, or any of a wide variety of available electronic devices for measuring angular position. Finally, the measured length and angle information is transmitted through the wire 840 to a calculation and display device such as the device depicted in FIG. 7.

To better visualize the aforementioned structure, consider FIG. 9 illustrating the top view of the measurement device depicted in FIG. 8. The measurement device 900 is attached to the line holder 910 and allows the line 920 to pass freely through the measurement device 900 or near enough to the measurement device 900 for length measurement. The measurement device 900 shown comprises the measurement device as in FIG. 8. Angle measurement is accomplished with the use of an upper line-guide 925 a lower line-guide 930, between which the line 920 extends outward toward the target object (i.e. the object 710). As shown, upper line-guide 925 and lower line-guide 930 associated with the measurement device 900 comprise curved wire vertically separated by at least the diameter of the line 920. Any shape and material for the upper and lower line-guides may be used. In one embodiment, the shape of the each of the line-guides is semi-circular. The upper and lower line-guides may be made of plastic, metal, or any number of suitable materials. Finally, referring to FIG. 9, the pivot point 935 comprises a pivot point as in FIG. 8.

The forgoing specification describes a device for use with a line holder capable of dispensing a line, comprising a length measurement device for measuring a length of line dispensed and an angle measurement device for measuring an angle of the line. A calculation device is used to calculate an approximate position of an object attached to the line based upon the measured length and the measured angle. The measurement and calculation devices may be mounted on a fishing rod and reel, allowing the user to measure the depth of underwater equipment.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

1. A measurement system for use with a line holder capable of dispensing a line, said measurement system comprising:
(a) a length measurement device capable of measuring a length of said line dispensed from said line holder; and
(b) an angle measurement device capable of measuring an angle of said line.

2. The system of claim 1, further comprising a calculation device capable of calculating an approximate position of an object attached to said line.

3. The system of claim 2, wherein said approximate position is calculated based upon said length and said angle.

4. The system of claim 3, wherein said line holder comprises a fishing reel.

5. The system of claim 3, wherein said line holder comprises a stationary fishing line dispenser.

6. The system of claim 3, wherein said calculation device comprises an electronic device capable of calculating said approximate position.

7. The system of claim 6, further comprising a display device capable of displaying said approximate position.

8. The system of claim 6, wherein said electronic device is capable of calculating a spatial relationship in at least one of two and three dimensions of said approximate position of said object attached to said line.

9. The system of claim 6, wherein said electronic device is capable of executing a set of program instructions responsive to an input from a user interface.

10. The system of claim 9, wherein said electronic device calculates said approximate position based upon said set of program instructions.

11. The system of claim 10, wherein said set of program instructions comprise instructions to account for an error of said approximate position, said error introduced by one or more of a diameter of said line, a weight of said object attached to said line, a shape characteristic of said object attached to said line, a speed of said object attached to said line, a deflection of said line, and an offset of said length of said line.

12. The system of claim 11, wherein said input from said user interface comprises one or more of said diameter of said line, said weight of said object attached to said line, said shape characteristic of said object attached to said line, said speed of said object attached to said line, said deflection of said line, and said offset of said length of said line.

13. The system of claim 6, wherein the length measurement device capable of measuring said length of said line dispensed from said line holder comprises a line counter and the angle measurement device capable of measuring said angle of said line comprises a clinometer.

14. The system of claim 13, wherein one or both of said clinometer and said line counter is selectively securable to said measurement system.

15. A measurement system for use with a line holder capable of dispensing a line, said measurement system comprising a calculation device capable of calculating an approximate position of an object attached to said line based upon a length of said line dispensed from said line holder and an angle of said line.

16. A measurement method for use with a line holder capable of dispensing a line, said measurement method comprising:
(a) measuring a length of said line dispensed from said line holder with a length measurement device; and
(b) measuring an angle of said line with an angle measurement device.

17. The method of claim 16, further comprising calculating an approximate position of an object attached to said line with a calculation device.

18. The method of claim 16, wherein said approximate position is calculated based upon said length and said angle.

19. A measurement method comprising calculating an approximate position of an object attached to a line based upon a length of said line dispensed from a line holder and an angle of said line with a calculation device.

20. An electronic measurement system for use with a fishing apparatus capable of dispensing fishing line into water, said electronic measurement system comprising:
(a) a measurement device capable of measuring a length of said fishing line dispensed from said fishing apparatus and an angle of said fishing line; and
(b) a calculation device capable of calculating an approximate position of an object attached to the end of said fishing line.

21. The measurement system of claim 20 where said fishing apparatus is a stationary fishing line dispenser.

22. The measurement system of claim 20 where said angle is an angle between said fishing line and said fishing apparatus.

23. The measurement system of claim 20 where said angle is an angle between said fishing line and the plane of the waterline.

24. The measurement system of claim 20 where said approximate position is a depth said line extends below said waterline.

25. The measurement system of claim 20 where said approximate position is a portion of said length of said fishing line released from said dispenser.

26. The measurement system of claim 20 where said approximate position is a portion of said length of said fishing line from said fishing apparatus to the waterline.

27. The measurement system of claim 20 where said approximate position is calculated based upon at least one of said angle and said length of said fishing line.

28. The measurement system of claim 20 where said calculation device comprises a microprocessor.

29. The measurement system of claim 20 where said measurement device is mountable on said fishing apparatus at a location such that the weight of said measurement device does not cause said measurement system to bow.

30. The measurement system of claim 20 where said measurement device comprises a clinometer capable of measuring said angle and a line counter capable of measuring said length.

31. The measurement system of claim 20 where said measurement device is selectively securable to said measurement system.

32. A measurement system for use with a fishing apparatus capable of dispensing fishing line into water, said measurement system comprising:
(a) a length measurement device capable of measuring a length of said fishing line dispensed from said fishing apparatus;
(b) an angle measurement device capable of measuring an angle of said fishing line;
(c) a calculation device capable of calculating a depth of an object attached to said line.

33. The measurement system of claim 32 where said fishing apparatus is a fishing reel.

34. The measurement system of claim 32 where said calculation device is capable of displaying said depth of said object.

35. The measurement system of claim 32 where said calculation device is capable of calculating and displaying a spatial relationship in at least one of two and three dimensions of said depth of said object.

36. The measurement system of claim 32 where said calculation device is capable of being programmed to account for an error of said depth, said error introduced by one or more of a diameter of said fishing line, a weight of said object attached to said fishing line, a shape characteristic of said object attached to said fishing line, a speed of said object attached to said fishing line, a deflection of said fishing line, and an offset of said length of said fishing line.

37. A method for measuring an approximate position of a fishing lure, said method comprising:
(a) measuring a portion of a length of a line dispensed from a line holder and an angle of said line; and
(b) calculating said approximate position of said fishing lure based upon said length and said angle.

38. The method of claim 37 where said measuring is electronic.

39. The method of claim 37 where said calculating is electronic.

40. A measurement system for use with a fishing line holder capable of dispensing a line, said measurement system comprising:
(a) a length measurement device capable of measuring a length of said line dispensed from said line holder; and
(b) an angle measurement device capable of measuring an angle of said line.

41. The system of claim 40, further comprising a calculation device capable of calculating an approximate position of an object attached to said line.

42. The system of claim 40, wherein said approximate position is calculated based upon said length and said angle.

43. The system of claim 40, wherein said line holder comprises a downrigger.
